(19) United States
(12) Patent Application Publication
(10) Pub. No.: US 2008/0281689 A1
(43) Pub. Date: Nov. 13, 2008

(54) EMBEDDED VIDEO PLAYER ADVERTISEMENT DISPLAY

(75) Inventors: Tomi Blinnikka, Berkeley, CA (US); Steven Horowitz, Oakland, CA (US); Lloyd Braun, Pacific Palisades, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/746,414

(22) Filed: May 9, 2007

(51) Int. Cl. G06Q 30/00

(52) U.S. Cl. 705/14

(57) ABSTRACT

The present disclosure describes systems and methods for retrieving and accessing, through a media player rendering a first piece of media, other pieces of media. Metadata may be provided with media content items, such as media files containing media streams. At predefined points in time in the video, the metadata is accessed and any other media associated with that frame of video are determined therefrom. This associated media is then displayed to the user automatically. The associated media may be an advertisement related to what was being shown in that frame, or point in the playback, or additional info about what was being shown in that frame, or point in the playback. The systems and methods can be used for displaying advertisements on web pages or in media players with limited display area.

### BACKGROUND

The Internet has become an accepted medium for delivery of all kinds of streaming media including video. Typically, such media assets in the form of video files, slide shows, flash animations or streaming video data are transmitted from a server to a client computing device for rendering (e.g., display over time) to the user or for local storage to support later rendering. Software modules such as media players and other programs are now provided or can be found for most computing devices so that media obtained from a remote source can now be displayed on nearly any computing device.

In addition, embedding media assets, such as movies and video clips, on web pages has become commonplace. Until recently, such “embedded” media display within a web page with other content was not common, media player applications typically being opened in a separate window instead. Now, however, there are several software systems available that support embedded media to be shown on a web page in way that static images have been displayed for years. Upon accessing these web pages, the media stream is automatically retrieved and rendered to the user in a predefined area within the web page. Typically, the web pages must be formatted for the display of the media and an area on the web page must be set aside to display the media in, as well as for any control elements, tool bars etc. that are associated with the media display.

Regardless of the context of the media display, e.g., whether the media is rendered alone or within a larger document such as a web page, the use of the display area is of primary importance. Most Internet services rely, at least in part if not solely, on advertisement revenue and the display of advertisements to users is of primary importance. In many cases, advertisers wish to show advertisements as close to the viewer's center of attention as possible. One way of doing this is to insert advertisements into the media asset being displayed, but this requires that each media asset be modified for each advertisement and it time consuming. Another way of placing advertisements includes placing advertisements in dedicated areas of the web page, such as the banner ads commonly located at the top of a web page. For example, banners, text, images, animated, or video advertisements are often displayed in areas set aside in a web page. Unfortunately, such advertisements are static in that they are predefined into a formatted location and do not change in any way as the media stream is being rendered (i.e., played in the display area).

In web page applications in particular, this is an issue, as the web page is primarily made up of static content displayed in areas within the page as dictated by the page's file. Therefore, any advertisement shown that is associated with the media must be in an area dedicated to a possibly static advertisement at the cost of useable display area for the media display.

### SUMMARY

The present disclosure describes systems and methods for retrieving and accessing, through a media player rendering a first piece of media, other pieces of media. Metadata may be provided with media content items, such as media files containing video streams. At predefined points in time in the stream, the metadata is accessed and any other media associated with that point in the stream are determined therefrom. This associated media is then displayed to the user automatically. The associated media may be an advertisement related to what was being shown in that frame, or point in the playback, or additional info about what was being shown in that frame, or point in the playback. The systems and methods can be used for displaying advertisements on web pages or in media players with limited display area.

The systems and methods disclosed provide advertisers the opportunity to display advertisements in the region of the page where the user is focusing their attention (the video) timed to be displayed based on a multitude of parameters to maximize the impression and relevance of the advertisement to the user. Advertisement content can be specified manually, or determined automatically by any of the above, and also personalized, based upon the content of the media or information about the user. If the advertisement is subsequently selected by a user, a media asset linked to the advertisement (such as a web page or media file with more information about the product or service advertised, or a web product or service itself) is displayed to the user. The linked media asset may be displayed in the current window by replacing the current content, by launching another browser window to display the linked media asset or by opening another browser tab to display the linked media asset. Upon clicking, the rendering of the media stream pauses, and can be resumed by clicking on the play control once again.

One aspect of the present disclosure is a method for rendering advertisements and associated media assets to a user. The method includes directing a media player to render a media stream in a first display area within a first application window and receiving, from the media player as the media stream is being rendered, a first trigger, such as a time code, associated with a first point in the media stream being rendered. In response to receiving the first trigger, the system displays, without interrupting the rendering of the media stream in the first display area, a first advertisement associated with the first time code in a second display area within the first application window. The method further may include detecting a selection input from a user at a time when a second point of the media stream is being rendered in the first display area, in which the selection input identifies the second display area. In response to the detection of the user selection of the advertisement, the method renders, with the media player in a third display area, a first media asset identified by or associated with the first advertisement.

Another aspect of the present disclosure is a method, and a computer-readable medium encoding instructions for the method, for displaying advertisements to users watching media streams in a web page. In the method, a media player is directed to render a media stream in a first display area of a web page within an application window. The method further includes receiving, from the media player while rendering the media stream in the first display area, a plurality of time codes including a first time code. A first advertisement associated with the first time code is identified and retrieved from a local or remote source. One of a plurality of second display areas within the application window is selected for the first advertisement and the first advertisement is displayed in the selected one of the plurality of second display areas.

Yet another aspect of the disclosure is a system for rendering an advertisement on a computing device. The system includes a media player that, in response to one or more commands, renders a media stream in a first display area designated by the one or more commands. While rendering media stream, the media player transmits at least one trigger including a first trigger a control module. Each trigger is associated with a different point in the playback of the media stream and is transmitted concurrently with the playback of its associated point. The system also includes the control module that generates the one or more commands to the media player. In addition, the control module receives the at least one trigger including the first trigger and, in response to receiving the first trigger, identifies a first advertisement associated with the first trigger. The control module then displays the first advertisement in a second display area designated by the control module while the media player is rendering the media stream in the first display area.

These and various other features as well as advantages will be apparent from a reading of the following detailed description and a review of the associated drawings. Additional features are set forth in the description which follows, and in part will be apparent from the description, or may be learned by practice of the described embodiments. The benefits and features will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments systems and methods described below and are not meant to limit the scope of the invention in any manner, which scope shall be based on the claims appended hereto.

FIG. 1 illustrates an embodiment of a high-level method of rendering a media asset based on a user input received during the rendering of a media stream.

FIG. 2 illustrates an embodiment of a system for accessing a media asset based on a user's interaction with a media player rendering while the media player is rendering a first media stream.

FIG. 3 is an illustration of a network architecture of connected computing devices as might be used to distribute and render media files.

### DETAILED DESCRIPTION

The present disclosure describes systems and methods for retrieving and accessing, through a media player rendering a first media asset such as video file, other media assets such as advertisements, web pages, and other video files.

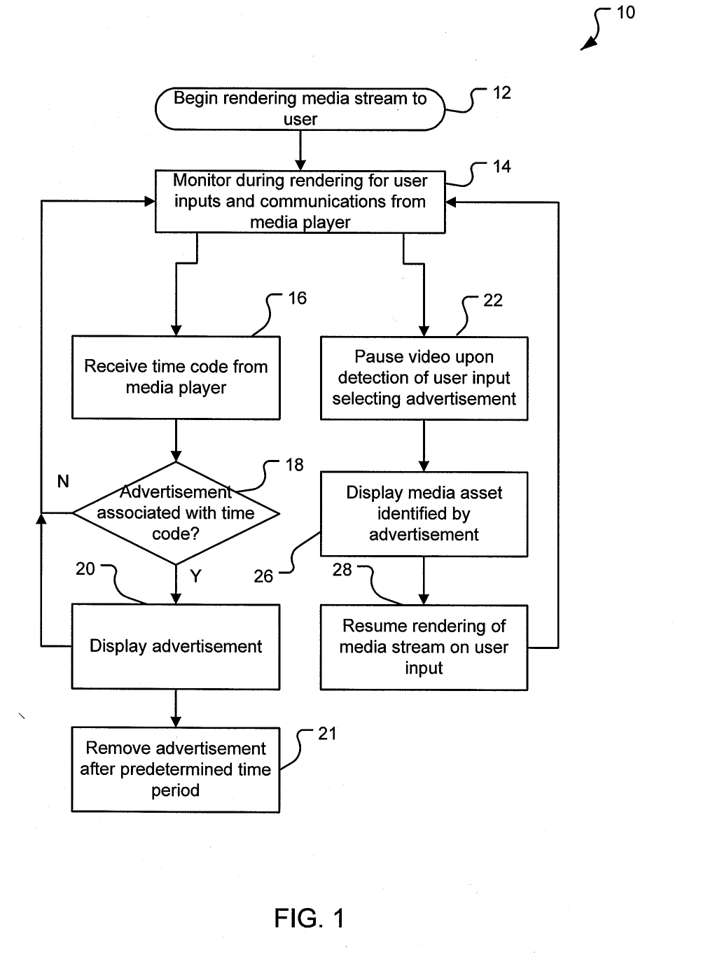

FIG. 1 illustrates an embodiment of a high-level method of rendering a media asset based on a user input received during the rendering of a media stream. In the method 10, a computing device, such as a computer, smart phone, personal data assistant, or the like as described in greater detail below, is used to render a page of content to a user. The computing device includes or is attached to a display device, such as a monitor or integral device display screen.

The page of content to be displayed includes a main video display area for displaying the visual component of a media stream. By interacting with the page, the user may cause the media stream to be rendered (i.e., video images played sequentially within the main video display area) by a media player or other video rendering module on the computing device. For example, user-selectable controls may be provided on the page that generate commands that, directly or indirectly, control the rendering of the media stream by the media player.

In the embodiment shown, the method 10 begins when the media player begins rendering a media stream to a user in a begin rendering operation 12. The begin rendering operation 12 is initiated by a user interacting with the page, such as by clicking on a “play video” icon or generating an input that initiates the rendering. In an embodiment, the page of content is controlled via a control module being executed by the computing device. In an embodiment, the control module is control code, such as a javascript or applet, that is being executed by the computing device as part of the display of the page of content. The control code may have been embedded in the page or alternatively may already reside on the computing device.

The media stream is rendered to the user in a display area on a page in a window, such as within a window generated by a browser, on the display device. For example, in an embodiment the media player may be rendering a movie or an episode of a syndicated television series in an area of a web page. The media stream may be a stream of data that is received over time from a remote location and rendered as it is received (i.e., the media stream is being streamed to the player). Alternatively, the media stream may be stored in a file or other data structure from which the renderable media data is retrieved and rendered by the media player.

During the rendering of the media stream, the control module monitors the system in a monitor operation 14. The monitor operation 14 includes monitoring for user inputs as well as monitoring the operation of the media player.

Periodically during the rendering, the media player generates a time code that indicates what is currently being rendered, i.e., indicative of the point in the media stream currently being displayed, in a receive time code operation 16. The time code may take the form of a simple time stamp indicating the amount of time from the start of the playback (e.g., the time code may be a number equal to the number of seconds from the beginning of the media stream at the standard playback speed). Alternatively, a time code may be an indicator generated by the media player in response to metadata contained in or otherwise part of the media stream data that the media player can interpret as part of the rendering of the media stream.

The time code generated by the media player is transmitted to the control module in the receive time code operation 16. The time code may be automatically transmitted, such as periodically or in response to other information known about the media stream. Alternatively, the time codes may be transmitted in response to a request sent to the media player by another device, e.g., a polling request sent by the source of the media stream. In the embodiment shown, upon receipt of the time code, the control module determines if the time code is associated with an advertisement in a first determination operation 18. As described in greater detail below, the first determination operation 18 may include accessing a store of metadata associating time codes for the particular media stream with predetermined advertisements, may include the transmission of a general advertisement request to an advertisement server, or may include a complex decision analysis to select an advertisement from a large group of advertisements based on whatever data that may be available concerning the user, what is being displayed at any particular point in the media stream, and what advertisements are available. If the first determination operation 18 does not identify an advertisement associated with the time code, then the method returns to the monitoring operation 14.

Although described with reference to time codes, the receive time code operation 16 may entail or include receiving any type of information from the media player that could be used as a trigger for displaying an advertisement. Examples of such information, in addition to time codes themselves, suitable for use as triggers include: Metadata, including tags, associated with the media or any particular point or segment of the media that is accessible to the control module via the media player; Closed caption information and text; Voice recognition information that could be generated by a voice recognition module analyzing the audio of the media stream being rendered; Character recognition information that could be generated by an image or character recognition module analyzing the visual data that is being displayed by the media player; Audio changes such as changes in volume, frequency, or music; and media changes such as changes in brightness or the identification of scene transitions. Some triggers may be generated by the media player while others may be generated by different modules. Regardless, any such triggers, in addition to timing information such as time codes, may be used by the control module to determine if an advertisement should be displayed and be used in the selection of the advertisement as described below. Thus, in the balance of the description the reader should be aware that when time codes are referred to, any trigger may be substituted instead of or in addition to time codes generated by the media player.

If the first determination operation 18 identifies an advertisement associated with the time code, then a display advertisement operation 20 is performed. As discussed in greater detail below, the display advertisement operation 20 includes retrieving the advertisement associated with the time code, selecting a display area on the page adjacent or near the main video display area to display the advertisement in, and displaying the advertisement in the selected area. The display advertisement operation 20 does not interrupt the rendering of the media stream and, in an embodiment, does not utilize the resources of the media player in any way. Because the advertisement is displayed within the same application window as the rest of the page and the media stream, the advertisement will not be blocked by a pop-up window blocker.

The first determination operation 18 may be performed for each time code received from the media player or, alternatively, may only be performed for certain predetermined time codes. For example, in an embodiment in which advertisements are selected based on information unrelated to the specific time code received (e.g., advertisements are selected at random, selected based only on metadata related to the media stream as a whole, or selected based only on information unrelated to the media stream such as the user's demographic), a default may be set so that new advertisements are selected by the first determination operation 18 with a predetermined periodicity, such as every five minutes, every thirty seconds, at every chapter or segment change indicated by the media player, or on some other basis.

The display advertisement operation 20 may include one or more dynamic or animated effects to attempt to draw the user's attention away from the media stream. For example, a new advertisement may be animated to appear to slide out from the main video display area into an adjacent display area so that the advertisement is rendered next to the main video display area. The content formerly in the adjacent display area may also be animated to appear to be pushed aside, pushed into yet another display area, crushed or simply covered up by the advertisement's appearance. Many different transition effects are known in the art and any such now known or later developed may be utilized by the control module. For example, the advertisement may be overlaid (e.g., a transparent overlay) over some or all of the main video display area. For example, an animation may appear in the bottom left hand corner of the main video display area or an advertisement of text or images may be animated to be displayed as scrolling across the bottom or the top of the main video display area.

In addition, it should be noted that operations of the method 10 may be repeated many times as a media stream is being rendered, thus displaying multiple advertisements over time in response to different time codes. The display advertisement operation 20 may, each time it is performed, select a different display area or transition effect for displaying the current advertisement. For example, a first advertisement may be displayed as sliding out from the bottom border of the main video display area, while a second advertisement may fade in above the main video display area. Thus, the advertisements are even more dynamically presented to the user. The different display areas and effects may be selected at random or based on any information or decision tree known. For example, display areas for advertisements may be dictated by the metadata associated with the media file, may be dictated by the advertisement, or may be dictated by the page's designer. In addition, more than one display area may be selected for an advertisement so that the advertisement appears to move over time. Other criteria for selecting display areas are known and any suitable method or criteria may be used.

For example, in an embodiment an advertisement may be an image such as a banner ad. The display advertisement operation 20 may retrieve the image from a location, which may be a remote location from the computing device, learned as part of the first determination operation 18. The retrieved image may then be display in some area of the page that heretofore was displaying other content. The original content may be moved to a different area (for example, text may be pushed down on the page) or removed and replaced with the advertisement.

In the embodiment shown, the advertisement is displayed for a predetermined period of time and then the advertisement is removed in a remove advertisement operation 21 so that the selected area returns to displaying its original content. In the embodiment shown, if a second time code associated with a different advertisement is received while still displaying the first advertisement, the second advertisement may be displayed in a different display area so that it is displayed concurrently with the first advertisement. Alternatively, the second advertisement may replace the first advertisement in the selected display area. In yet another embodiment, the first advertisement may be displayed until some other trigger occurs such as the display of another advertisement, a dismissal input from the user or termination of the rendering of the media stream. Regardless of when and whether the advertisement is ultimately removed, after the display operation 20 the system returns to the monitoring operation 14.

As shown in FIG. 1, in addition to monitoring for time codes from the media player, the control module also monitors for user inputs. If an advertisement is being displayed as a result of the display advertisement operation 20, one of the user inputs monitored for is a user selection of the advertisement. As is common with advertisements displayed on computing devices, the advertisement may include information that identifies an associated media asset. For example, an advertisement may be or contain a link to a media asset at a location on a network, such as the Internet, accessible to the computing device.

Upon detection of a user input selecting the advertisement, for example by clicking on the advertisement or a hyperlink displayed thereon, the control module pauses the rendering of the media stream in a pause operation 22. The pause operation 22 may include requesting at time stamp or other indicator from the media player of the point in the media stream at which the rendering was interrupted by the pause command.

After pausing the media stream, the control module then displays the media asset identified by the advertisement in a render media asset operation 26. The render media asset operation 26 may include retrieving the media asset from a remote location identified by the advertisement selected by the user. The media asset may be displayed in the video display area that was previously displaying the media stream or, alternatively, may be displayed in a second window that is generated specifically for the purpose.

In the embodiment shown, the media asset is or includes renderable video, and the control module directs the media player to begin rendering the media asset in a render media asset operation 26. Upon termination of the render media asset operation 26, either through a user input terminating the render operation 26 or some other terminating occurrence, the system resumes rendering the media stream from the point at which the media stream was paused in a resume rendering operation 28 and the system returns to the monitoring operation 14. In the embodiment shown, a user input is required to resume rendering the media asset.

The following is an example of how an embodiment of the method 10 described above may operate. A user accesses a web page on cars with a browser application. The browser application retrieves the web page, creates a window and interprets the code of the web page to generate the displayed content into the window. The code of the web page includes a script (e.g., a javascript) or other code element that is executed by the browser as part of interpreting the code of the web page. The web page includes an embedded media stream of a sports car test. The user begins the rendering 12 of the media stream by selecting a play button or, alternatively, the media stream begins rendering automatically upon display of the web page.

During the rendering, the javascript monitors 14 the system by waiting for inputs from various sources to be received. At some point during the rendering of the media stream, a time code is received 16 by the executing javascript and it is determined 18 that it is associated with a banner ad for a brand-name sports car. The banner ad is retrieved from a remote location on the Internet and then displayed 20 in area of the web page adjacent to the video display area. By displaying the banner ad in an area of the web page, the user's experience of watching the rendering media stream is not interrupted while the user's attention is drawn to the newly displayed banner ad because of its proximity to the main video display area.

In the example, the banner ad is a link to a short video commercial for the named-brand sports car. If the user subsequently clicks on the banner ad, the media stream is paused 22, a new browser window is opened and the commercial is then rendered 26 in the new browser window. Upon completion of the commercial, e.g., when the user closes the new browser window or the commercial plays to completion, the media stream resumes 28 playing from where it was paused.

Note that each media asset associated with an advertisement may be a media stream or a web page containing embedded media that requires the use of the media player to be rendered. Furthermore, each media asset containing video may itself have advertisements associated with its time codes. Therefore, through the method 10 a user may be able to “drill down” from a first media stream, through several different media assets.

The method 10 is well adapted to deliver advertisements associated with different items shown in different locations throughout a media stream. For example, during an episode of a television series, a viewer could click on an actor to receive an advertisement related to the clothing or jewelry worn by the actor. Similarly, a viewer could select a prop displayed in the background, such as a car or a consumer good like a chair, table or beer bottle, and have displayed to the viewer advertisements associated with those goods.

The method 10 is also well adapted to allow for easy dissemination of general educational information about items shown in a media stream. In this use, the method would display topics instead of advertisements that are associated with the media stream being rendered. For example, a child viewing a media stream about construction could select a topic banner for a specific piece of construction equipment, e.g., a crane, a dump truck, a track hoe, or a bulldozer, and thereby cause the display of another media stream related specifically with the selected piece of equipment.

The method 10 is further suitable for instructional videos in which different topic banners are displayed at different times so that a student can select any of the different topics to receive more detailed information about the topic selected. Thus a high-level video program about some subject, for example cooking a turkey, could allow the viewer to drill down to very detailed information, such as how to prepare a specific turkey rub, from another video program or series of programs.

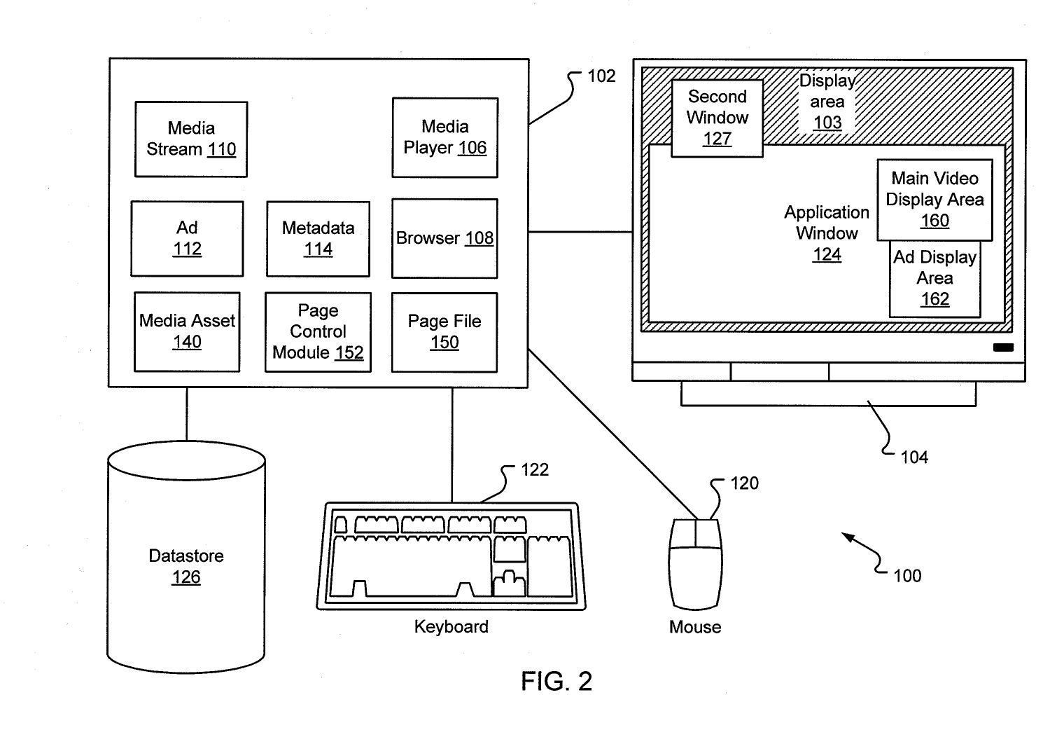

FIG. 2 illustrates an embodiment of a system for accessing a media asset based on a user's interaction with an advertisement rendered automatically during the rendering of a first media stream. In the embodiment discussed below, the system 100 will be discussed in terms of rendering a media stream that includes video content, i.e., a sequence of images meant to be sequentially displayed over time to create the impression of a moving scene. One skilled in the art will recognize that the media stream could equally be an audio stream (i.e., a sequence of audio sounds intended to be sequentially rendered over time to create the impression of a song, sound clip, variable tone, etc.), a combined audio-visual stream or any other stream containing media content intended to rendered over time.

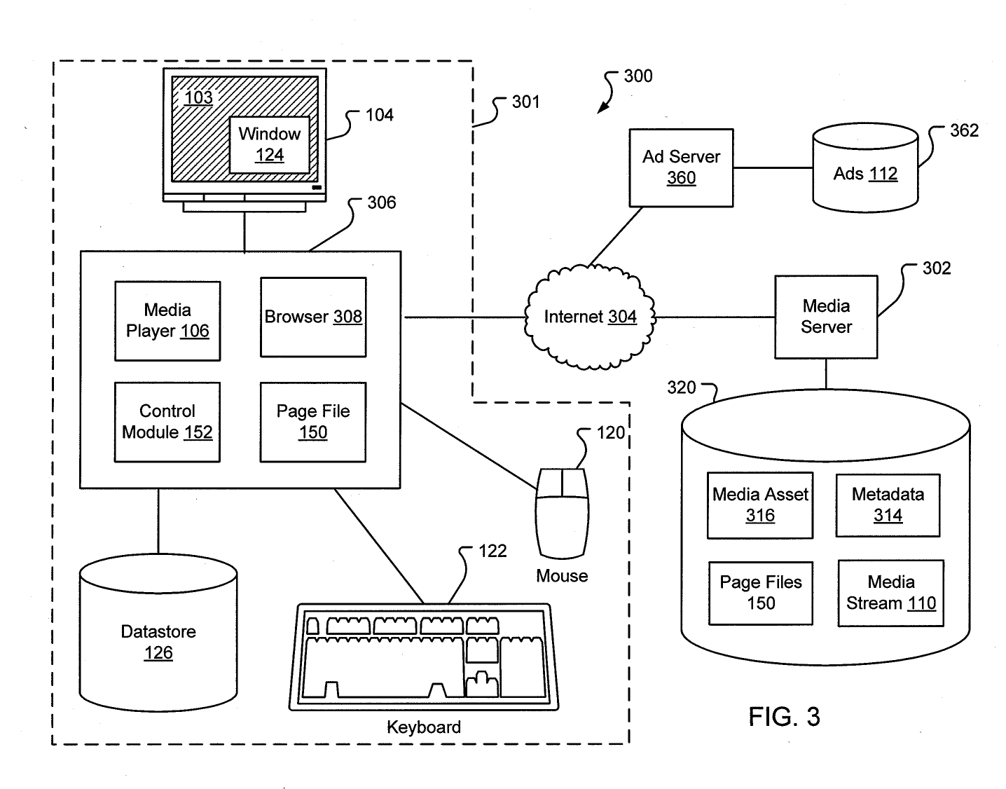

The system includes a computing device 102 connected to a display device 104 having a display area 103. The computing device 102, which may alternatively be referred to as rendering device, is capable of rendering media content, such as media assets 140 including media stream files 110 or other data structures that contain renderable media data or media content that is received in a stream of media data of some format. Many different types of computing devices may be rendering devices, as long as they are capable of rendering media files or streaming media. For example, a rendering device may be a personal computer (PC), web enabled cellular telephone, personal digital assistant (PDA) or the like, capable of receiving media data from a datastore 126 or over a network (see FIG. 3), either directly or indirectly (i.e., via a connection with another computing device).

Examples of computing devices are well known in the art. By way of example, computing devices, such as the computing device 102 shown, include a processor and memory for storing data and software. Computing devices may further be provided with operating systems and may be able to execute software applications in order to manipulate, transmit and receive data. In the computing device, local files, such as a media stream file 110 or media asset 140, may be stored on a mass storage device, or datastore 126, that is connected to or part of any of the computing devices described herein. A mass storage device and its associated computer-readable media, provide non-volatile storage that can be accessed by one or more computing devices. Although the description of computer-readable media contained herein refers to a mass storage device, such as a hard disk or CD-ROM drive, it should be appreciated by those skilled in the art that computer-readable media can be any available media that can be accessed by a computing device.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

In the embodiment shown in FIG. 2, the computing device 102 includes a media player 106 and at least one application 108, illustrated by the browser application 108, capable of retrieving, interpreting and rendering a page with embedded media and control code in an application window 124, as discussed above. In the embodiment shown, the application 108 has retrieved a page file 150 that includes control code and generated therefrom an application window 124 displaying content and also executed the control code to so that a control module 152 for the page is active and monitoring the system for specific actions by various other components and inputs, such as from a pointing device 120 or keyboard 122, given by the user. In an embodiment, the control module 152 is a separate program from the other applications 108 and the media player 106 and communications between these components may be through each component's application programming interface.

In an embodiment, the window 124 may take up only a portion of the total available display area 103, as shown. Alternatively, the window 124 may take up the entire display area 103. The window 124 will include different areas displaying different content. For example, a first area may display text from the page file, a main video display area 160 may display the video portion of the embedded media and a set of controls for controlling the playback of the embedded video, another area may be displaying a navigation bar, and other areas may be displaying other content as directed by the page file 150.

The control module 152 is capable of re-designating different areas of the page in the application window 124 to display different content based on inputs and actions detected. In an embodiment, this is accomplished by setting up the page file to include or define separate areas, blocks, content formats or sections of the displayed page. For example, the DIV element in language HTML may be used to segregate a displayed page into different areas. The content in each area may then be independently changed by the control module 152 by changing only the content associated with a particular area and re-rendering the page within the window 124.

In an embodiment, the control module 152 monitors for time codes received from the media player and user inputs selecting various areas or content items, such as links, displayed in the window 124. As discussed above, upon detection of a time code or other information transmitted from the media player during rendering of a media stream 110, the control code can perform various actions including identifying, selecting and retrieving advertisements 112 from a local or remote source and causing such advertisements 112 to be displayed within the application window 124 into an advertisement display area 162. This is performed by re-designating one or more display areas within the application window 124 to display the advertisement 112 instead of the original content. As described above, displaying the advertisement may include such effects as having the ad display window 162 appear to slide out from the main video display area 160 (such as sliding out from the bottom of the main video display area 160 as shown), fade in or move around.

Regardless of the effect, the advertisement display area 162 is displayed without retrieving a new page file 150, but rather by changing how the content in the original page file is displayed. The advertisement is removed after a period of time or upon the occurrence of some other trigger as described elsewhere in this disclosure.

In addition, the display of advertisements 112 does not perceivably interrupt the rendering of the media stream by the media player in the display area designated for the display of media stream 110. Thus the user's experience of the rendering media stream 110 is not affected by the control code's changing of the content being displayed in the other areas of the window 124.

The control module 152 is also monitoring for user inputs related to displayed advertisements, such as a user click within the advertisement display area 162. As the control module 152 is aware of what is currently being displayed in each area of the window 124 even after re-designating some areas to display content different from that specified in the original page file 150, it can identify user inputs that are selections of the advertisements displayed. In response to such a user input, the control module 152 may then open a second window 127 for rendering a media asset 140 designated by the advertisement. The media asset 140 may be stored locally or may be retrieved from a remote source designated by the advertisement. Alternatively, the control code may display the media asset 140 in the original application window 124 by re-designating a display area of that window 124. If the media asset 140 is a video, audio or other type of asset that must be rendered over time, the control module 152 controls the operation of the media player 106 or other application 108 necessary for rendering the media asset 140.

In the embodiment shown in FIG. 2, the media stream 110 is located on the computing device 102 in the form of a renderable data file that contains renderable media data. In an alternative embodiment, the media stream 110 may be streamed to the computing device 102 to otherwise accessed from a remote source (not shown). The media data in the media stream 110 includes data that when rendered generate a sequence of images over time within the main video display area 160, possibly accompanied by sounds rendered through a speaker (not shown).

In addition, the media stream 110 may include or may be associated with metadata 114 that identifies information associated with the media stream. For example, associated metadata 114 may also be stored on some form of computer-readable media (e.g., CD, RAM, hard disk, etc.) on or accessible to the computing device 102. In an embodiment, metadata 114 may include such information as the name of the media stream, the artist, copyright information, and other data related to the media stream's properties, such as the topic, the author, a description of the content, etc. In addition, the metadata 114 may include data related to different points within the media stream 110. For example, such metadata may indicate that certain time codes for the media stream 110 are associated with specified advertisements 112 and provide information for retrieving the advertisements 112 such as a URL or other network locator information. Alternatively, the metadata 114 may include data that defines segments within the media stream identifying start and end points as well as other information, which could be used for advertisement selection.

In an embodiment, an advertisement 112 may take many forms. The data may be textual information (e.g., describing the history of the church or the model of the car). The data may be an image or set of images (e.g., a banner advertisement for the car or a tourist promotional advertisement for visiting the church). The data may further information identifying an media asset 140, such as a local address of a media file (e.g., C:/my videos/car.mp4) or a network address like a Uniform Resource Locator (e.g., http://www.teamstupid.com/Honorary_files/Don't%20Cheat.mpeg) of a media file.

In an embodiment, the input is a movement and click with a mouse 120 in which the user moves a visible pointer over an area within the application window 124 and “clicks” a button on the mouse 120. The mouse-click described is but one method of generating a user input that identifies an area or location in the displayed media stream on the application window 124 during the rendering of the media stream to the user and others are also possible. For example, the pointing device may be a trackball. Likewise, a touch screen and stylus may be used. In addition, the keyboard 124 may be used to enter inputs that move a point or select different portions of the application window 124 as the sequence of images are being displayed. Any suitable method, now known or later developed for receiving user inputs in a window may be used.

Regardless of the exact user input, the control module 152 detects the user input and resolves the input to determine what location (e.g., a location within the advertisement display area 162) in the application window 124 was selected. If the selection is within the advertisement display area 162 or otherwise indicates that the user wishes to access the advertisement, the control code 152 pauses the rendering of the media stream 110 in the main video display window 160 as described elsewhere. Rendering of the media stream 110 resumes when triggered, such as by another user input.

The control module 152 may be one or more separate programs running independent of the other elements of the system 100 (i.e., the media player 106) or it may be a component of one of those elements (e.g., it may be built into or provided with the media player 106). For example, in an embodiment, the control module 152 takes the form of a software plug-in or script, that is adapted to receive the user input information from the user interface devices 122, 120 and further adapted to issue commands and receive information from the media player 106, such as through a time code, tag and metadata application programming interface (API). In this example, the control module 152 may issue requests for metadata to the media player's API and then control the operation (e.g., by issuing commands to pause and resume rendering, to open a new window, to render a designated media asset, etc.) of the media player 106 through the same or another API.

The control module 152 may first retrieve the metadata 114. This data may be retrieved directly from the media stream 110 if the metadata 114 is included in the stream 110, from a separate source or from the media player 106. If it is retrieved from the media player 106, a request may need to be created and transmitted to the media player 106. The request may be a request for metadata associated with the currently rendered portion of the media stream 110 or may be a request for all the metadata 114 of the media stream 110 along with information that indicates to the control module 152 what point of the media stream is currently being rendered.

As discussed above, the metadata 114 may identify an advertisement 112 that is associated with a time code. In an alternative embodiment, there may be no metadata 114 and, instead, the control module 152 identifies an advertisement 112 by some other means. For example, for every time code or for certain predefined time codes, the control module 152 may request a new advertisement from an ad server (not shown). In yet another embodiment, the control module 152 may cycle through a predetermined set of advertisements 112 maintained in a storage location such as an advertisement database.

Upon termination of the display of the media asset 140 in the second window 127, such as by closing the second window 127 rendering the media asset, the media asset 140 being rendered to completion, or otherwise terminating the display of the media asset (such as via a “back” or “return to rendering” button provided on a toolbar associated with the second application window 127), the control module 152 may then direct the media player 106 to resume the rendering the media stream 110 in the main video display area 160 in the application window 124 at the point in the media stream 110 where the user input interrupted the rendering.

When interrupting the rendering of the media stream 110, in order to resume at the proper point, the control module 152 may receive information from the media player 106 such as the name and location of the media stream 110 being interrupted and the portion currently being rendered when the user input was received. This information may be stored for later use upon termination of the display of the text, media asset 140, or other content identified by the metadata.

FIG. 3 is an illustration of a network architecture of connected computing devices as might be used to distribute and render media files. The architecture includes a rendering device 301 in communication with a media server 302 via a network 304.

In the architecture 300, the various computing devices are connected via a network 304. One example of a network 304 is the Internet. Another example is a private network of interconnected computers, however, any communication network, now known or later developed, may be used including for example a cellular phone network, an simple text messaging network, a paging network or some other network. The format and contents that are communicated between the various computing devices may differ depending on the network used. For example, if the Internet 304 is the network, the communications may take the form of Hypertext Transfer Protocol (HTTP) requests and responses in which data files are transferred between devices. If the network is a mobile telephone network such as a Global System for Mobile Communications (GSM) network, communications may comply with some other communication protocol such as the Short Message Service (SMS) Point-to-Point protocol.

A rendering device 301 may be any computing device that can render media, such as those discussed above with reference to FIG. 2. In addition, rendering devices 301 as shown in FIG. 3 may further include hardware and software adapted to allow the computing device to interact with and send and receive data from other computing devices (e.g., the media server 302 or advertisement server 360) via the network 304. Examples of suitable network computing devices include a personal computer (PC), web enabled cellular telephone, personal digital assistant (PDA) or the like, capable of receiving media data over the network 304, either directly or indirectly (i.e., via a connection with another computing device).

For example, as shown in FIG. 3, a user's rendering device 301 is a personal computer 306 provided with various software modules (e.g., media player 106, browser 308 and control module 152) and hardware peripherals (e.g., datastore 126, keyboard 122, mouse 120 and display 104). In an alternative embodiment, the rendering device 301 may a single, integrated device such as a cellular phone, PDA, or laptop computer.

In the embodiment shown, the rendering device 301 includes a media player 106, and a control module 152 associated with the page file 150 as described above. In addition, the rendering device 301 as shown includes a browser 308. The media player 106, among other functions, provides the ability to convert information or data into a perceptible form and manage media related information or data so that the user may personalize their experience with various media content items. Media player 106 may be incorporated into the rendering device by a vendor of the device, or obtained as a separate component from a media player provider or in some other art recognized manner. As will be further described below, it is contemplated that media player 106 may be a software application, or a software/firmware combination, or a software/firmware/hardware combination, as a matter of design choice, that serves as a central media manager for a user of the rendering device and facilitates the management of all manner of media content items and services that the user might wish to access either through a computer or a personal portable device or through network devices available at various locations via a network.

The browser 308 can be used by a consumer to identify and retrieve page files 150 accessible through the network 304. An example of a browser includes software modules such as that offered by Microsoft Corporation under the trade name INTERNET EXPLORER, or that offered by the Mozilla Foundation under the trade name FIREFOX, or the software or hardware equivalent of the aforementioned components that enable networked intercommunication between users and service providers and/or among users. In an embodiment, the browser 308 and media player 106 may operate jointly to allow page files 150 referencing or containing a renderable media stream 110 to be rendered in response to a single consumer input, such as selecting a control or a link to a page file 150 on a web page rendered by the browser 308. Note that the page files 150 may be generated dynamically in response to requests or may exist as a data file and server from storage in the datastore 320.

Another example of a rendering device 301 is a purpose-specific music player device such as an MP3 player that can retrieve and render page files 150 directly from a network 304 or indirectly from another computing device connected to the network 304. One skilled in the art will recognize that a rendering device 301 may be configured in many different ways and implemented using many different combinations of hardware, software, or firmware.

The embodiment of the architecture 300 shown in FIG. 3 further includes a media server 302. The media server 302 can be a server computing device or group of computing devices connected to the network 304 that work together to provide services as if from a single network location or related set of network locations. In a simple embodiment, the media server 302 could be a single computing device such as a personal computer. However, in order to provide services on a mass scale to multiple rendering devices, an embodiment of a media server 302 may include many different computing devices such as server computers, dedicated datastores and database servers, routers, and other equipment distributed throughout many different physical locations.

The media server 302 may include software or servers that make other content and services available and may provide administrative services such as managing user login, service access permission, digital rights management, and other services made available through a service provider. Although some of the embodiments of the invention are described in terms of media content items that are music and particularly in the form of songs, embodiments can also encompass any form of streaming or non-streaming media data including but not limited to news, entertainment, sports events, books, web page or perceptible audio or video content. It should also be understood that although the present invention is described in terms of media content and specifically audio content, the scope of the present invention encompasses any content or media format heretofore or hereafter known.

In the embodiment shown, media server 302 includes or is connected to a datastore 320 such as a media database 320. The database 320 may be distributed over multiple servers, discrete datastores, and locations. In an embodiment, in addition to media content, the media database 320 stores various metadata 314 associated with different media streams 110 on the network 304. The metadata 314 stored in the media database 320 may include metadata 314 that describes the media streams 110. Such metadata 314 may include information identifying: the artist or artists of a media streams 110; the publisher of the media streams 110; if music, the album from which the media streams 110 was obtained; the release data of the media streams 110; various categorization information such as genre of the media streams 110; and reviews, ratings and other information supplied by third parties describing the media streams 110. The metadata of pre-existing media streams 110 may then be stored and maintained centrally on the media server 302 and thus made available to all users.

In addition, as described above the metadata 314 may include metadata 314 for each stream 110 that divides the stream 110 into segments and then associates different segments with different advertisements 112. This metadata 314 may be stored as part of its associated media stream 110, as a separate file associated with the file containing the media stream 110, or in some other manner.

In the embodiment shown, the media player 106 may render a media stream 110 streamed or otherwise transmitted from the media server 302. In the embodiment, the rendering device 301 renders media streams 110 in a main video display area (not shown) and displays advertisements in an advertisement display area (not shown) within the application window 124 as described in FIG. 2. As the media stream 110 is rendered, the media player 106 transmits time codes or other indicators of what is being rendered to the control module 152.

In embodiments that include metadata, in response to the initial rendering or to receipt of time codes, the metadata 314 may be retrieved. The metadata 314 may be requested from the server 302 in response to the user input. Alternatively, if the metadata 314 has been transmitted with the renderable media data of the media stream 110, the metadata 314 may be accessed from where it is locally maintained. In an embodiment, the metadata 314 may be retrieved via the media player 106 or may be retrieved directly from the source.

After receipt of the metadata 314, the control module 152 performs the same identifications as described above and determines if and what advertisement 112 is associated with the time code received from the media player 106. In the embodiment shown, the advertisement 112 identified by the metadata 314 may be a remote advertisement 112 that is accessible only through the network 304. In this case, the metadata 314 may include information, such as a network address or a URL, for the advertisement 112. Using this information, the control module 152 may then either retrieve advertisement 112 and display it in an advertisement display area of the window 124. Regardless, the media stream 110 being concurrently rendered by the media player 106 to the user via the attached display device 104 as described above is not interrupted even though the content being displayed in at least one area of the window 124 is changed.

If a subsequent user selection of the displayed advertisement 112 occurs, the media asset 316 is retrieved as directed by the advertisement 112. The media asset 316 may exist in a datastore 320 or at any location accessible to the computing device 306. For example, in an embodiment, the media asset 316 may be downloaded to the device 306 with the advertisement so that it is locally stored in anticipation that the user may select the advertisement.

In an embodiment, advertisements 112 may be determined to be associated with a particular time code in any suitable manner. In the embodiment shown in FIG. 3, an advertisement server 360 is provided to assist in the selection of an advertisement 112 in the event that the control module 152 determines that an advertisement 112 should be displayed but can not determine that a specific advertisement 112 is associated with a given time code or indicator. In that situation, the control module 152 may transmit a request containing some or all of the information known such as the media stream 110 being rendered, the time code received, information concerning the user rendering the media stream 110, and any metadata 114 known to the control module. The ad server 360 may utilize this information in selecting an advertisement 112 or may select advertisements based on some other criteria. Regardless, the ad server 360 selects and transmits an advertisement 112 from an advertisement datastore 362 to the device 306. The control module 152 then displays the advertisement 112 received as described above.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

While various embodiments have been described for purposes of this disclosure, various changes and modifications may be made which are well within the scope of the present invention. For example, many different media assets may be identified in a media stream and each of these media assets may in turn have metadata that associate different locations within different portions to yet other media assets. As the user “drills down” through multiple media assets, a user interface may be provided, such as a visual tree representation, that allows the user to easily return to rendering any of the media asset or the original media stream. Numerous other changes may be made which will readily suggest themselves to those skilled in the art and which are encompassed in the spirit of the invention disclosed and as defined in the appended claims.

1. A method for rendering a media asset with a media player comprising:
directing a media player to render a media stream in a first display area within a first application window;
receiving, from the media player as the media stream is being rendered, a first time code associated with a first point in the media stream being rendered;
in response to receiving the first time code, displaying, without interrupting the rendering of the media stream in the first display area, a first advertisement associated wit the first time code in a second display area different from the first display area within the first application window;
detecting a selection input from a user at a time when a second point of the media stream is being rendered in the first display area, the selection input identifying the second display area; and
in response to the detecting, rendering, with the media player in a third display area, a first media asset identified by the first advertisement.

2. The method of claim 1 further comprising:
receiving, over time from the media player as the media stream is being rendered, a plurality of time codes from the media player including the first time code;
in response to each time code received, transmitting a request for an advertisement associated with the respective time code; and
receiving the first advertisement.

3. The method of claim 2 wherein metadata associates a plurality of different advertisements with a plurality of time codes for the media stream including associating the first advertisement with the first time code and wherein each advertisement identifies a media asset and the method further comprises:
accessing the metadata to determine the first advertisement associated the first time code; and
retrieving the first advertisement based on the metadata.

4. The method of claim 3 wherein the media stream comprises renderable media data and the metadata.

5. The method of claim 3 wherein the metadata is stored in a remote datastore and accessing further comprises:
transmitting a request to the remote datastore identifying the first time code;
receiving a response from the remote datastore identifying the first advertisement; and
retrieving the first advertisement based information in the response.

6. The method of claim 5 further comprising:
in response to each time code received, transmitting a request to the remote datastore identifying the respective time code.

7. The method of claim 1 further comprising:
ceasing the rendering of the media stream in the first display area in response to detecting the selection input.

8-9. (canceled)

10. The method of claim 7 further comprising:
upon termination of the rendering of the first media asset, rendering, with the media player, the media stream in the first display area starting from the second point of the media stream.

11. The method of claim 8 further comprising:
receiving a termination input from the user, the termination input requesting termination of the rendering of the first media asset in the third display area; and
closing the second application window.

12. The method of claim 10 wherein ceasing further comprises:
pausing the rendering of the media stream in the first display area until termination of the rendering of the first media asset.

13. The method of claim 1 further comprising:
replacing the first advertisement, in the second display area within the first application window after a predetermined period of time, with original content displayed in the second display area prior to the display of the advertisement

14. (canceled)

15. A method comprising:
directing a media player to render a media stream in a first display area within an application window;
receiving, from the media player while rendering the media stream in the first display area, a plurality of time codes including a first time code;
retrieving a first advertisement associated with the first time code;
selecting one of a plurality of second display areas within the application window for the first advertisement, the selected one of the second display areas displaying application window content when the first time code is received;
displaying the first advertisement in the selected one of the plurality of second display areas; and
after displaying the first advertisement, removing the first advertisement by displaying the application window content displayed in the selected one of the second display areas when the first time code was received.

16. The method of claim 15 further comprising:
receiving a second time code associated with a second advertisement from the media player;
selecting a different one of the plurality of second display areas within the application, the different one of the second display areas displaying application window content when the second time code is received; and
displaying the second advertisement in the different one of the plurality of second display areas; and
after displaying the second advertisement, removing the second advertisement by displaying the application window content displayed in the different one of the second display areas when the second time code was received.

17. The method of claim 15 wherein the selected one of the plurality of second display areas is displaying content when the first time code is received and the method farther comprises:
displaying the content in a third display area different from the first display area and the selected one of the second display areas while displaying the first advertisement in the selected one of the plurality of second display areas.

18. The method of claim 17 further comprising:
receiving a second time code associated with a second advertisement from the media player;
selecting a different one of the plurality of second display areas within the application;
displaying, in response to receiving the second time code, the second advertisement in the different one of the plurality of second display areas and the content in the selected one of the display area different from the first display area.

19. (canceled)

20. The method of claim 15 wherein the selecting operation is performed after receiving the first time code.

21. A system for rendering advertisements on a display of a computing device comprising:
a media player that in response to one or more commands, renders a media stream in a first display area designated by the one or more commands and, while rendering media stream, transmits at least one trigger including a first trigger, each trigger indicative of a different point in the media stream; and
a control module that generates the one or more commands to the media player and that receives the at least one trigger including the first trigger, wherein the control module in response to receiving the first trigger identifies a first advertisement associated with the first trigger and displays the first advertisement in a second display area designated by the control module while the media player is rendering the media stream in the first display area.

22. The system of claim 21 wherein the first display area and the second display area are within an application window.

23. The system of claim 22 further comprising:
an application that generates the application window and executes the control module in response to a user command to access a resource.

24. The system of claim 21 further comprising:
an advertisement module that provides advertisements to the control module in response to requests.

25. The system of claim 21 further comprising:
metadata associated with the media stream that associates at least one advertisement with at least one trigger including associating the first advertisement with the first trigger.

26. The system of claim 21 wherein at least one advertisement identifies a media asset stored remotely from the computing device and wherein the control module retrieves the media asset in response to a user selection of the at least one advertisement.

27. The system of claim 26 wherein the first display area and the second display area are within an application window and wherein the control module causes the media asset to be displayed in a second window different from the application window.

28. The system of claim 26 wherein the control module further commands the media player to pause rendering of the media stream in response to a user selection of the at least one advertisement.

29. The system of claim 21 wherein at least one trigger transmitted by the media player is selected from a time code, metadata describing the media stream, audio displayed during the rendering of the media stream, images displayed during the rendering of the media stream, and closed caption information associated with the media stream.
